(19) United States
(12) Patent Application Publication
(10) Pub. No.: US 2024/0340920 A1
(43) Pub. Date: Oct. 10, 2024

(54) TRIGGERING SENSING IN A WIRELESS COMMUNICATION SYSTEM

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA)

(21) Appl. No.: 18/747,666

(22) Filed: Jun. 19, 2024

Related U.S. Application Data
(63) Continuation of application No. PCT/CN2021/140995, filed on Dec. 23, 2021.

(51) Int. Cl. H04W 72/232

(52) U.S. Cl. CPC H04W 72/232

(57) ABSTRACT

In some wireless communication scenarios, a user equipment (UE) may perform sensing and feedback measurements or results, which a transmit-and-receive point (TRP) may then use to determine information about objects and/or conditions in the vicinity of the TRP. However, the UE might be in a power-saving state when the TRP requires the UE to perform the sensing. In some embodiments, the UE can be triggered to perform sensing as part of the paging information transmitted from the TRP, e.g. in the paging downlink control information (DCI) and/or in the paging message or in another message scheduled by the DCI.

### CROSS-REFERENCE TO RELATED APPLICATIONS

This application is a continuation of International Application No. PCT/CN2021/140995, filed on Dec. 23, 2021, and entitled “Triggering Sensing in a Wireless Communication System,” application of which is incorporated herein by reference in its entirety.

### TECHNICAL FIELD

The present application relates to triggering an apparatus to perform sensing in a wireless communication system.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a UE may wirelessly transmit information to a TRP in an uplink communication over a particular frequency (or range of frequencies) for a particular duration of time. The frequency and time duration are examples of resources, typically referred to as time-frequency resources. Other examples of resources may include resources in the spatial domain (e.g. the beam that is used), resources in the power domain (e.g. transmission power), etc.

The TRP may sometimes need to determine information about one or more objects and/or conditions present in the vicinity of the TRP. As one example, the TRP might sometimes need to determine the humidity at one or more locations in the vicinity the TRP. As another example, the TRP might need to track the movement of objects in the vicinity of the TRP, e.g., the TRP might need to track the location of robots moving throughout a manufacturing facility in the vicinity of the TRP.

The TRP itself might not be able to directly determine the information about the objects and/or conditions present in the vicinity of the TRP.

### SUMMARY

The TRP may wirelessly communicate with one or more UEs in the vicinity of the TRP. The UEs may perform sensing and feedback measurements or results based on the sensing, which the TRP may then use to determine the required information about the objects and/or conditions in the vicinity of the TRP. As one example, one or more UEs in the vicinity of the TRP may each include a sensor that senses humidity. If the TRP requires humidity readings, the TRP may request that each UE sense humidity and transmit the sensed humidity value to the TRP. As another example, one or more UEs may be mounted at various locations throughout a manufacturing facility in the vicinity of the TRP. Each of the UEs may sense electromagnetic waves reflected off of robots, e.g. via the use of radar. Information based on sensed waves may be transmitted by a UE to the TRP in an uplink transmission. An example of information based on the sensed waves may be one or more bits representing a property of one or more of the sensed waves (e.g. amplitude or direction). Another example of information based on the sensed waves may be one or more bits representing a location and/or speed and/or direction of movement of the robot, which the UE derives using the sensed waves.

In some scenarios, a UE performing sensing might only need to perform the sensing when requested by the TRP. The TRP may request that a UE perform sensing on an on-demand basis. Therefore, the UE might not know when the TRP is going to request that the UE perform sensing. The UE might be in a power-saving state when the TRP requires the UE to perform the sensing. For example, the UE and network may operate according to a radio resource control (RRC) protocol, and the UE may be in an RRC Idle state or RRC Inactive state when the TRP wants to instruct the UE to perform sensing. The UE might be deployed by the network for the primary purpose of sensing, and therefore the UE might operate in a power-saving state all or most of the time. For example, the UE might be a low-cost low-power UE dedicated to sensing and feeding back sensing results.

If the UE is in a power-saving state, such as an RRC Idle state or RRC Inactive state, and the TRP wants to instruct the UE perform sensing, the TRP may first have to page the UE to cause the UE to perform a network access procedure, e.g. to cause the UE to perform initial access using a radio access channel (RACH) protocol. Then, once a connection is established (e.g. the UE is in an RRC Connected state), the TRP can instruct the UE to perform the sensing. However, in some scenarios the latency associated with the UE performing the network access procedure may be unacceptable. The TRP may require the sensed feedback from the UE promptly, i.e. there may only be a small window of time between when the TRP determines that the UE is to perform sensing and when the UE must start sensing to feedback the results of the sensing.

To try to help address the latency requirement explained above, in some embodiments the UE can be triggered to perform sensing as part of the paging information transmitted from the TRP, e.g. in the paging downlink control information (DCI) and/or in the paging message or in another message scheduled by the DCI.

For example, in one embodiment there is provided a method performed by an apparatus, such as a UE. The method may include receiving information related to paging. The information related to paging may include an indication used for triggering the apparatus to perform sensing. The method may further include the apparatus decoding the information. The method may further include the apparatus performing the sensing in response to the indication. In another embodiment, there is provided a method performed by a device, e.g. a by a network device, such as a TRP. The method may include generating the information related to paging, the information including the indication used for triggering the apparatus (e.g. UE) to perform the sensing. The method may include transmitting the information for receipt by the apparatus.

In some embodiments, the indication used for triggering the apparatus to perform sensing may be in DCI. The DCI may relate to paging, e.g. the DCI may also or alternatively be used for scheduling a paging message. For example, the DCI may have its cyclic redundancy check (CRC) value scrambled using a paging radio network temporary identifier (P-RNTI). In some embodiments, the indication in the DCI may be a field in the DCI that schedules a message in a data channel. The message configures one or more parameters relating to the sensing. In other embodiments, the indication triggering the sensing may be in a message (e.g. a paging message) in a data channel, rather than in DCI. The message in the data channel may be scheduled by the DCI.

A technical benefit of some embodiments includes the ability for a TRP to promptly trigger a UE in a power-saving state to perform sensing, because the triggering may occur in paging information. In some embodiments, the TRP may be able to use paging DCI and/or a message scheduled using paging DCI to trigger the UE to perform sensing and to possibly configure a parameter related to the sensing, e.g. to configure the resources used by the UE to transmit the feedback obtained from sensing. The UE might not need to perform a network access procedure (such as an initial access procedure using a RACH procedure) to be triggered by the TRP to perform the sensing and to be able to feed back the sensing results to the TRP.

In some embodiments, the paging information may also or instead be used by the TRP to indicate to the UE that a configuration related to the sensing has changed, and to possibly provide an updated sensing configuration.

In other embodiments, control information that is not necessarily paging information may instead be used to trigger a UE to perform sensing and/or to configure the sensing.

Corresponding apparatuses and devices for performing the methods herein are also disclosed.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates user equipments (UEs) communicating with a TRP, according to one embodiment;

FIG. 6 illustrates power consumption for a UE when operating in a power saving state, according to one embodiment;

FIG. 7 illustrates paging notification monitoring by a UE, according to one embodiment;

FIG. 8 illustrates an example radio access channel (RACH) procedure;

FIG. 9 illustrates a method for triggering sensing when a UE is in a power-saving state, according to one embodiment;

FIG. 10 illustrates triggering sensing and configuring one or more sensing parameters, according to one embodiment;

FIGS. 11 and 12 illustrate example values of a field in downlink notification, according to various embodiments;

FIG. 13 illustrates two example ways in which both a paging message and a sensing message may be scheduled by a same DCI;

FIG. 14 illustrates a few different examples of possible formats for a sensing message;

FIG. 15 illustrates an example way to indicate that a configuration related to sensing has changed and provide a sensing configuration, according to one embodiment;

FIG. 16 illustrates a few different examples of possible formats for a sensing configuration;

FIG. 17 illustrates two example ways in which both a paging message and a sensing configuration may be scheduled by a same DCI;

FIG. 18 illustrates triggering a UE in a power-saving state to perform sensing and/or indicating to the UE that a configuration related to sensing has changed, according to one embodiment; and

FIG. 19 illustrates a method performed by a device and an apparatus, according to one embodiment.

### DETAILED DESCRIPTION OF THE EMBODIMENTS

For illustrative purposes, specific example embodiments will now be explained in greater detail below in conjunction with the figures.

### Example Communication Systems and Devices

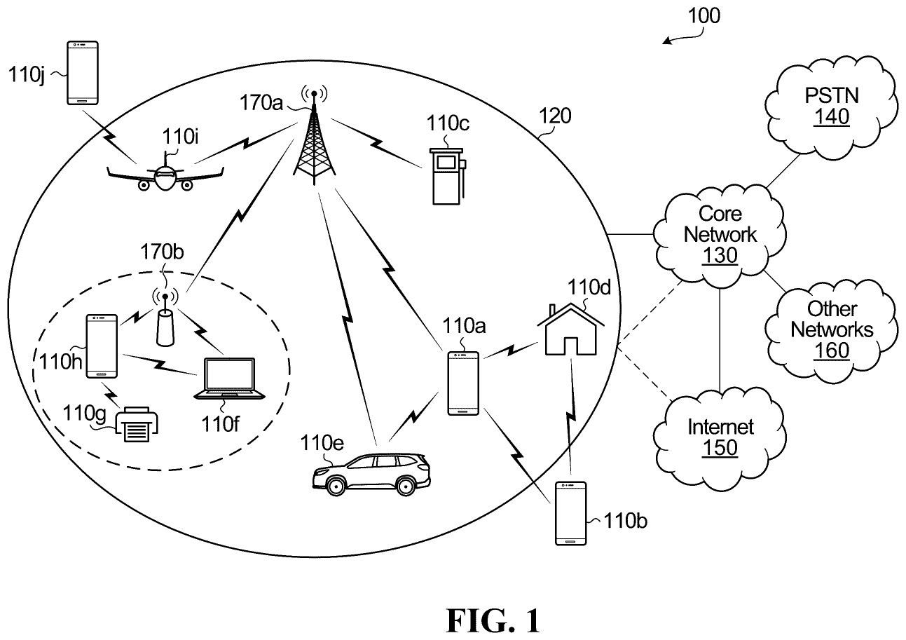

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

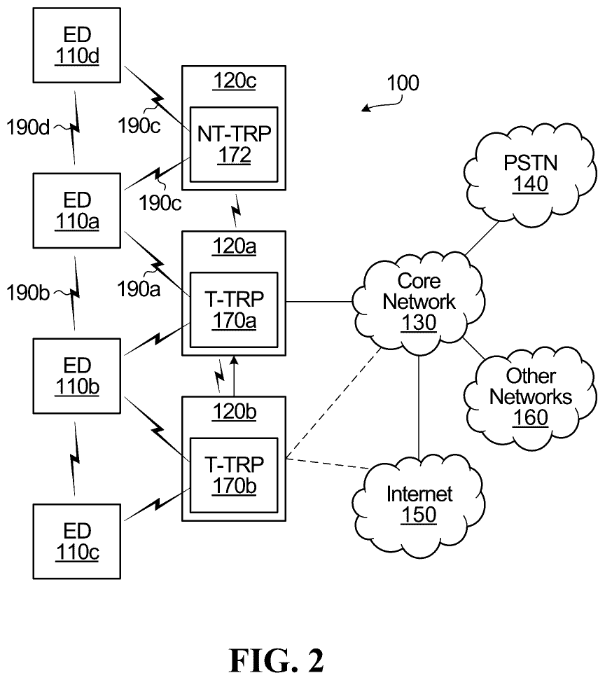

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

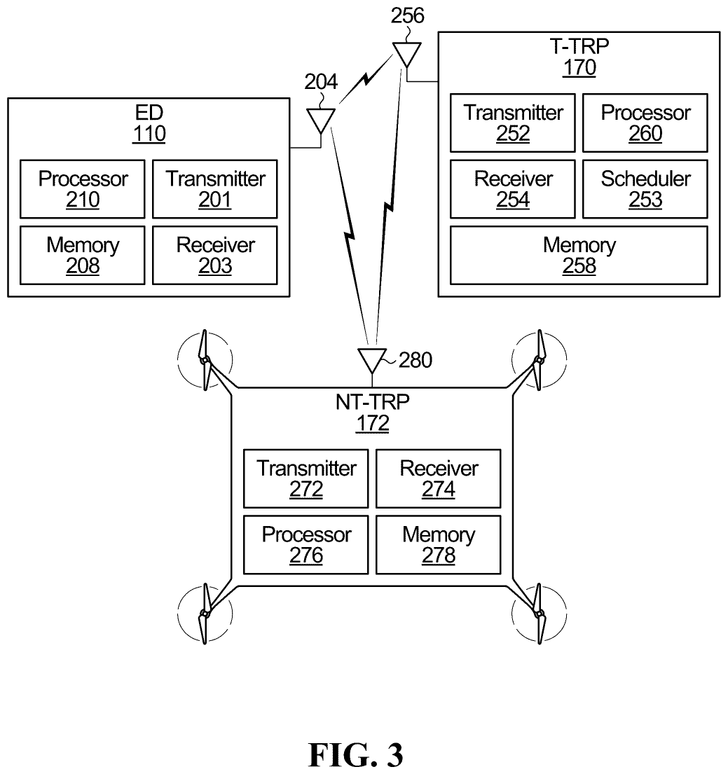

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

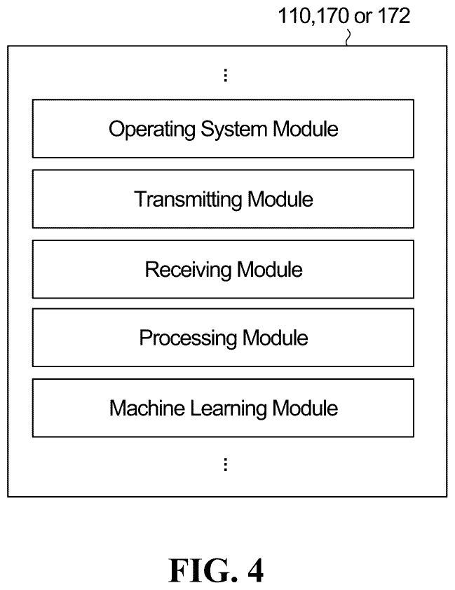

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is discussed herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

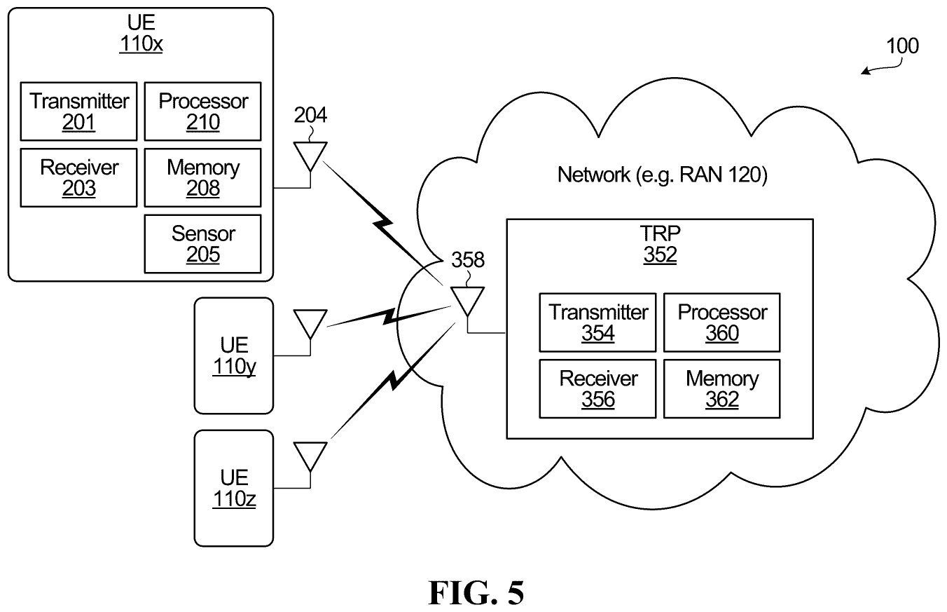

FIG. 5 illustrates three EDs communicating with a TRP 352 in the communication system 100, according to one embodiment. The three EDs are each illustrated as a respective different UE, and will be referred to as UEs 110x, 110y, and 110z. However, the EDs do not necessarily need to be UEs. In the following, the reference character 110 will be used when referring to any one of the UEs 110x, 110y, 110z, or any other UE (e.g. the UEs 110a-j introduced earlier).

The TRP 352 may be T-TRP 170 or NT-TRP 172. In some embodiments, the parts of the TRP 352 may be distributed. For example, some of the modules of the TRP 352 may be located remote from the equipment housing the antennas of the TRP 352, and may be coupled to the equipment housing the antennas over a communication link (not shown). Therefore, in some embodiments, the term TRP 352 may also refer to modules on the network side that perform processing operations, such as resource allocation (scheduling), message generation, encoding/decoding, etc., and that are not necessarily part of the equipment housing the antennas and/or panels of the TRP 352. For example, the modules that are not necessarily part of the equipment housing the antennas/panels of the TRP 352 may include one or more modules that: generate information related to paging (e.g. DCI scrambled by a paging ID and/or paging messages), generate downlink notifications (e.g. paging notifications), schedule downlink transmissions (e.g. downlink notifications in DCI or messages in a data channel) on configured resources in a control channel or data channel, generate scheduled downlink transmissions, process uplink transmissions (such as sensing feedback received from a UE 110), etc. The modules may also be coupled to other TRPs. In some embodiments, the TRP 352 may actually be a plurality of TRPs that are operating together to serve UEs 110, e.g. through coordinated multipoint transmissions.

The TRP 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the TRP 352 performs (or controls the TRP 352 to perform) much of the operations described herein as being performed by the TRP 352, e.g. generating the information related to paging (e.g. DCI scrambled by a paging ID and/or paging messages), generating downlink notifications, scheduling downlink transmissions (e.g. scheduling downlink notifications in DCI or messages in a data channel), generating scheduled downlink transmissions, processing uplink transmissions (such as sensing feedback), etc. Generation of information for downlink transmission (e.g. generation of information related to paging, downlink notifications, downlink transmissions, etc.) may include arranging the information in a message format, encoding the message, modulating, performing beamforming (as necessary), etc. Processing uplink transmissions may include performing beamforming (as necessary), demodulating and decoding the received messages, etc. Decoding may be performed by a decoding method that decodes according to a channel coding scheme, e.g. polar decoding if the data is encoded using a polar code, low-density parity check (LDPC) decoding algorithm for a LDPC code, etc. Decoding methods are known. For completeness, example decoding methods that may be implemented include (but are not limited to): maximum likelihood (ML) decoding, and/or minimum distance decoding, and/or syndrome decoding, and/or Viterbi decoding, etc.

Although not illustrated, the processor 360 may form part of the transmitter 354 and/or receiver 356. The TRP 352 further includes a memory 362 for storing information (e.g. control information and/or data).

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the TRP 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the TRP 352 is NT-TRP 172, then the transmitter 354 may be or include transmitter 272, the receiver 356 may be or include receiver 274, the processor 360 may be or include processor 276, and the memory 362 may be or include memory 278.

Each UE 110 (e.g. each of UEs 110x, 110y, and 110z) includes a respective processor 210, memory 208, transmitter 201, receiver 203, and one or more antennas 204 (or alternatively panels), as described earlier. Only the processor 210, memory 208, transmitter 201, receiver 203, and antenna 204 for UE 110x is illustrated for simplicity, but the other UEs 110y and 110z also include the same respective components.

The processor 210 performs (or controls the UE 110 to perform) much of the operations described herein as being performed by the UE 110, e.g. monitoring for downlink notifications (such as paging notifications in DCI), e.g. by performing the blind detection described herein, receiving information related to paging (e.g. DCI scrambled by a paging ID, a downlink notification, and/or a scheduled message), decoding the information, performing sensing, generating messages for uplink transmission (e.g. to provide the sensing feedback), etc. Decoding may be performed by a decoding method that decodes according to a channel coding scheme, e.g. polar decoding if the data is encoded using a polar code, low-density parity check (LDPC) decoding algorithm for a LDPC code, etc. Decoding methods are known. For completeness, example decoding methods that may be implemented include (but are not limited to): maximum likelihood (ML) decoding, and/or minimum distance decoding, and/or syndrome decoding, and/or Viterbi decoding, etc. Generation of messages for uplink transmission may include arranging the information in a message format, encoding the message, modulating, performing beamforming (as necessary), etc.

Although not illustrated, the processor 210 may form part of the transmitter 201 and/or receiver 203.

The UE 110 further includes a sensor 205. Sensor 205 is a device or module whose purpose is to perform sensing, e.g. to detect events or changes in its environment. The implementation of the sensor 205 is application-specific and depends upon the object and/or condition being sensed. In some embodiments, the sensor 205 might sense a parameter, e.g. a parameter measured by the sensor 205. For example, the sensor 205 might be a tactile sensor, or a strain sensor, or a humidity sensor, or a camera sensor (to take a digital image), etc. As another example, the sensor 205 may be used for radio frequency (RF) sensing, in which case the sensor 205 might be or include an antenna. For example, the sensor 205 may sense electromagnetic waves reflected from at least one object. An example of electromagnetic waves is radio waves. If the sensor 205 is used for RF sensing, the sensing might be active or passive. An example of active sensing is the sensor 205 including a transmitter that transmits electromagnetic waves (e.g. radio waves) and a receiver that detects reflections of the waves off of one or more objects. An example of passive sensing is the sensor 205 not transmitting the electromagnetic waves, but only including a receiver that detects reflections of waves off of one or more objects. In the case of passive sensing, the TRP 352 or another device separate from the UE 110 would transmit the waves. Active sensing may sometimes be called monostatic sensing because the transmitter and the receiver for transmitting/receiving the electromagnetic waves are the same device. Passive sensing may sometimes be called bistatic sensing because the transmitter and receiver are different devices, e.g. the TRP 352 sends the signals to be sensed, and the UE 110 receives the signals.

Although only one sensor 205 is illustrated, in general the UE 110 might have multiple sensors. For example, the UE 110 might have a camera to capture a digital image, a humidity sensor to measure humidity, and an RF sensor for detecting reflections of waves. Additionally, or instead, a single sensor 205 might perform multiple different types of sensing.

The processor 210 determines feedback to send to the TRP 352 obtained from the sensing by the sensor 205. The feedback is implementation specific and depends upon the type of sensing performed and/or the information required by the TRP 352. In some embodiments, the feedback comprises a parameter directly measured by the sensing. For example, if the sensor 205 senses humidity, the feedback may comprise the humidity measured by the sensor. As another example, if the sensor 205 detects reflections of waves, the feedback may be a measured amplitude and/or direction of one or more of the waves, and/or a relative or absolute time of arrival of one or more of the waves. In some embodiments, the feedback comprises information derived from the sensed parameter(s). For example, the feedback may comprise an indication of a location, speed, distance, orientation, shape and/or direction of travel of an object, where the location, speed, distance, orientation, shape and/or direction of travel of the object is determined by the processor 210 based on the waves detected by the sensor 205. For example, the UE 110 may implement radar and feedback the determined result (e.g. location of an object), rather than the measured parameters of the waves themselves.

### Power Saving State

In some embodiments, a UE 110 may operate in one or multiple states, e.g. a power saving state, a connected state, etc. When operating a power saving state, the UE 110 might not fully occupy the system resources available for downlink and/or uplink transmission, e.g. the UE might not utilize all transmission parameters and time-frequency resources available for downlink and/or uplink transmission. For example, the UE 110 might not constantly (or as often) monitor for network instructions on the downlink, e.g. the UE 110 might not monitor a control channel, such as the PDCCH, as often. For example, if the UE 110 is a reduced capacity (RedCap) commercial device, a wearable device, a low-cost industry wireless device, an IoT device, etc., then the UE 110 may operate in a power saving state much or all of the time. In some embodiments, the UE 110 might be deployed primarily for the purposes of sensing and therefore operate in a power saving state much or all of the time.

In some wireless communication systems, the UE 110 and network operate according to a radio resource control (RRC) protocol. The RRC protocol has different states in terms of the UE operating behavior and radio resource usage. For example, the RRC protocol may include: an RRC Idle state in which there is no RRC connection established with the network and no actual RRC configured resources are used; an RRC Connected state (also referred to as “Active state”) in which an RRC connection is established and full RRC configured radio resources are used by the UE; and an RRC Inactive state in which partial RRC resources are reserved and the RRC functions of the UE may be reduced, e.g. to help save power. In some embodiments, the Idle and Inactive states may be considered power-saving states.

In some embodiments, within a single state (e.g. within a power-saving state) there may be different operation modes that consume different amounts of UE power, e.g. a default operation mode and an enhanced operation mode. Each operation mode may correspond to a respective power (usage) mode. Example power modes might include sleep, wake-up, downlink reception only, etc. Multiple modes may be within a single state, and/or different states may have different modes. In some cases, transitioning from one mode to another mode might involve changing state. For example, the modes of “sleep” and “awake for downlink notification” might be two different power modes in a same power saving state, whereas the mode “both downlink reception and uplink transmission” may be a mode in a non-power-saving state (or normal transmit/receive power state).

In some embodiments, after or upon completing initial access to connect to the network, the UE 110 enters a default operation mode that is associated with lower power consumption and is within a power saving state. The UE 110 remains in the default operation mode by default, and may temporarily move into an enhanced operation mode on demand, e.g. in response to being paged and/or in response a trigger from the TRP 352 to perform sensing. Moving into the enhanced operation mode might or might not cause the UE 110 to transition to a new or different state.

In some embodiments, when the UE 110 is in a power saving state, monitoring the downlink control channel, e.g. for DCI, might only be performed in a wake-up period of a discontinuous reception (DRX) cycle or DRX_on window.

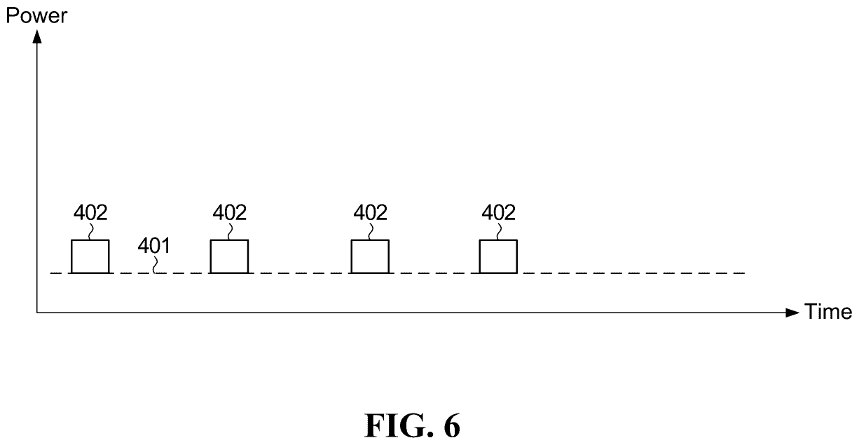

FIG. 6 illustrates power consumption for the UE 110 when operating in a power saving state, according to one embodiment. Within the state, the UE 110 may operate in different power modes, e.g.: a default sleep mode, which is a very low power mode when in a sleep duration; and a wake-up mode, which is a low power mode when in a wake-up duration (e.g. when in a wake-up period of a DRX cycle). Although not shown, there may be other modes within the power saving state, e.g. a temporary higher power mode for relatively short transmission of data, e.g. for transmitting feedback based on the sensing. The default sleep mode is indicated by dashed line 401. Periodic wake-up durations 402 are interspersed between the sleep durations, e.g. possibly at regular intervals, such as according to a DRX cycle. In a wake-up duration 402, the UE 110 consumes more power in order to perform operations such as monitoring for downlink notifications (e.g. paging notifications). Each wake-up duration 402 might possibly be a wake-up period of a DRX cycle or DRX_on window, depending upon the implementation.

In some embodiments, when in a power-saving state, e.g. when in an RRC Idle state, RRC Inactive state, or some other power-saving state, the UE 110 monitors for a downlink notification, such as a paging notification. For example, the UE 110 may be configured to enter a periodic wake-up duration to perform the monitoring.

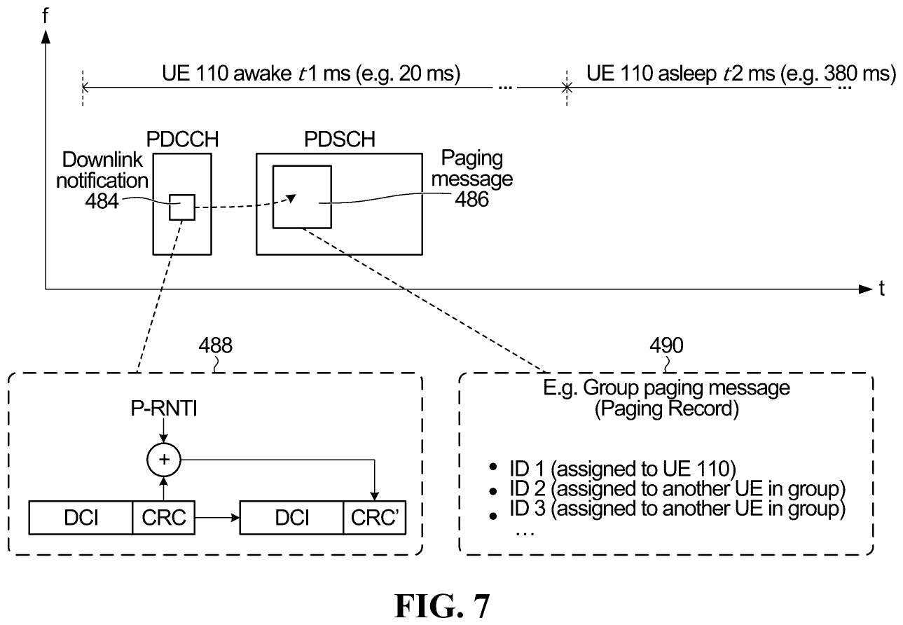

FIG. 7 illustrates paging notification monitoring by UE 110, according to one embodiment. During a wake-up duration of t1 ms, UE 110 monitors a downlink control channel for downlink control information (DCI) carrying a downlink notification 484 for UE 110. In the illustrated example, the downlink control channel is a PDCCH, and the downlink notification 484 is a paging notification that schedules a paging message 486 in a downlink data channel. The downlink data channel is illustrated as a PDSCH.

In general, at a paging occasion the TRP 352 might or might not have a paging notification for the UE 110, but if a paging notification is to be sent to the UE 110, the TRP 352 may dynamically send it in one of several possible PDCCH candidates, e.g. in one of different possible search spaces in the PDCCH. Therefore, the UE 110 performs blind detection to determine if a paging notification is present. The blind detection may operate as follows: for each PDCCH candidate, the UE 110 attempts to decode the DCI carried by the PDCCH candidate, unscrambles the cyclic redundancy check (CRC) value of the DCI using an ID (e.g. a P-RNTI), and checks if the CRC value is valid. If the CRC value is not valid, the UE 110 assumes there is no paging notification in that PDCCH candidate. If the CRC value is valid, the UE assumes the decoded DCI of the PDCCH candidate is correct and carries a paging notification for UE 110.

In the illustrated example, the paging notification is downlink notification 484, and (as shown in stippled bubble 488) it includes DCI having a CRC value that is scrambled by a paging-specific identifier referred to as a paging-radio network temporary identifier (P-RNTI). The scrambling may be implemented via an XOR operation. The DCI schedules paging message 486 in the data channel. Based on the scheduling information in the DCI, the UE 110 locates and decodes the paging message 486 in the PDSCH.

In the illustrated example, the paging message 486 is a group paging message, i.e. it can possibly page more than one UE. This is shown in stippled bubble 490. The P-RNTI may therefore be a paging ID assigned to the group, i.e. a group ID. The UE 110 looks for its individual ID in the paging message 486. If the UE's individual ID is present, the UE 110 is being paged, e.g. meaning the TRP 352 has data to send to the UE 110. Although the paging message 486 is illustrated as a group paging message, it may alternatively be dedicated to the UE 110, depending upon the implementation.

If UE 110 is paged, the UE 110 may perform a network access procedure (e.g. an initial network access procedure) to move into a connected state to synchronize and transmit/receive messages to/from the TRP 352. The network access procedure may include a radio access channel (RACH) procedure.

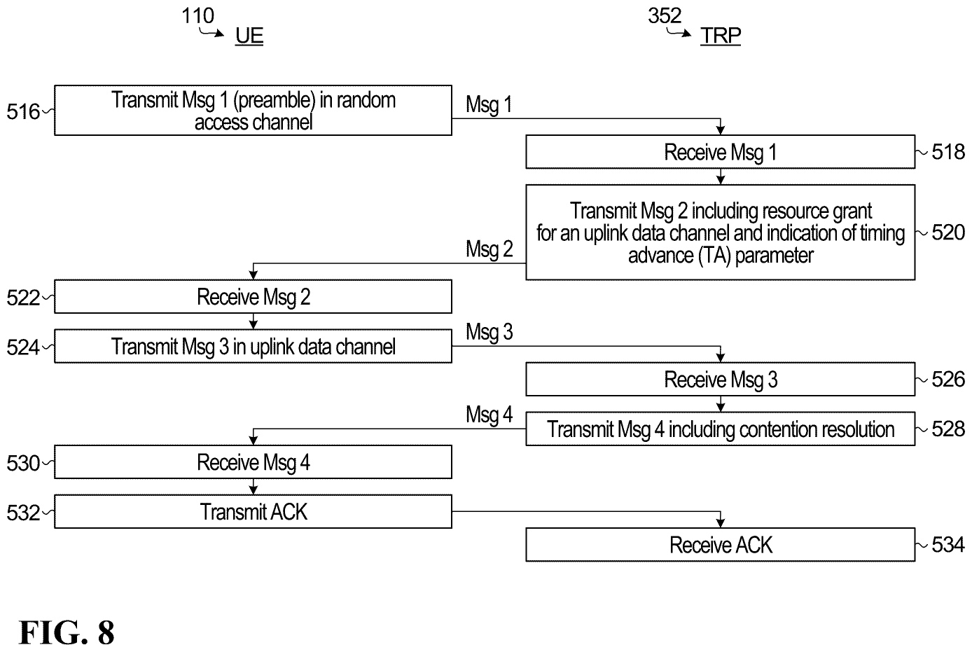

On example of a RACH procedure is illustrated in FIG. 8. The example RACH procedure of FIG. 8 is contention-based and includes four main steps that involve the exchange of four messages: Msg 1, Msg 2, Msg 3, and Msg 4.

At step 516, the UE 110 selects and transmits a preamble on a random access channel to the TRP 352. The message including the preamble is referred to as Msg 1. In step 518, Msg 1 is received by the TRP 352.

The TRP 352 detects the preamble transmitted by the UE 110, and in response the TRP 352 transmits a response, which is sometimes called a random access response (RAR). The response is transmitted in step 520 on a downlink data channel, such as a PDSCH. The response includes information referred to as Msg 2.

Msg 2 may include a resource grant for a transmission on an uplink data channel, which the UE 110 uses to transmit Msg 3 described below. Msg 2 may further include other information, some of which may be dependent upon Msg 1. Examples of other information in Msg 2 include (but are not limited to): (1) an identity of the random access preamble that was sent in Msg 1; and/or (2) a timing advance (TA) value to be used by UE 110 for uplink synchronization, where the TA value may be determined by the TRP 352 based on the received transmission of Msg 1; and/or (3) one or more power adjustment parameters to be used by UE 110 for uplink transmissions. In illustrated box 520, it is assumed the Msg 2 includes at least a resource grant and a TA value, but this is only an example.

At step 522, the UE 110 receives Msg 2. At step 524, the UE 110 sends an uplink data transmission in the uplink data channel using the resource grant present in Msg 2. The information sent in the uplink data transmission in step 524 includes Msg 3. Msg 3 may include data to be sent from the UE 110 to the TRP 352 (e.g. RRC connection or reconnection information). Msg 3 also includes a contention resolution identity. The transmission of Msg 3 in the uplink data channel may be performed by UE 110 using the TA value and/or power adjustment indicated in Msg 2.

At step 526, the base station 170 receives Msg 3 in the uplink data channel. At step 528, the TRP 352 transmits a response on a downlink data channel, such as a PDSCH. The response carries information referred to as Msg 4. Msg 4 may include connection confirmation information. Msg 4 also includes the conflict resolution identity received in Msg 3. At step 530, UE 110 receives the downlink transmission of Msg 4 and concludes that Msg 4 is for UE 110 and that the random access procedure was successful because a valid contention resolution identity is decoded by UE 110. At step 532, UE 110 transmits an acknowledgement (ACK) to the TRP 352 on an uplink control channel, such as a PUCCH. The ACK is received by the TRP 352 at step 534.

The RACH procedure described in relation to FIG. 8 is contention-based because the same preamble may possibly be used by different UEs on the same time-frequency resources of the random access channel. A contention-free RACH procedure may instead be performed using a variation of FIG. 8 in which a dedicated preamble is assigned to UE 110 and used by UE 110 in Msg 1. In a contention-free RACH procedure, Msg 3 and Msg 4 may omit the contention resolution identity value. Also, the RACH procedure in FIG. 8 is just one example of a RACH procedure. Other variations of a RACH procedure exist, e.g. a two-step RACH in which the number of message exchanges may be reduced.

Upon completion of the RACH procedure, the UE 110 may transition out of the power saving state to a network connected state, e.g. an RRC connected state. For example, the UE 110 might by default operate in an RRC Idle or RRC Inactive state and monitor for paging, e.g. as shown in FIG. 7. In response to being paged, the UE 110 may perform the RACH procedure of FIG. 8 and transition out of the RRC Idle or RRC Inactive state to an RRC connected state.

### Triggering the UE 110 to Perform Sensing

In some scenarios, the UE 110 might only need to perform the sensing when requested by the TRP 352. The TRP 352 may request that the UE 110 perform sensing on an on-demand basis. Therefore, the UE 110 might not know when the TRP 352 is going to request that the UE 110 perform sensing. The UE 110 may be in a power-saving state when the TRP 352 requires the UE 110 to perform the sensing. For example, the UE 110 may be in an RRC Idle state or RRC Inactive state when the TRP 352 wants to instruct the UE 110 to perform sensing. The UE 110 might be deployed by the network for the primary purpose of sensing, and therefore the UE 110 might operate in the power-saving state all or most of the time. For example, the UE 110 might be a low-cost low-power UE dedicated to sensing and feeding back sensing results.

If the UE 110 is in a power-saving state, such as an RRC Idle state or RRC Inactive state, and the TRP 352 wants to instruct the UE 110 perform sensing, the TRP 352 first pages the UE 110 (e.g. via the paging message 486 in FIG. 7) which causes the UE 110 to perform a network access procedure, such as the RACH procedure of FIG. 8 to establish a connection with the network. Then, once a connection is established (e.g. the UE 110 is in an RRC Connected state), the TRP 352 can instruct the UE 110 to perform the sensing.

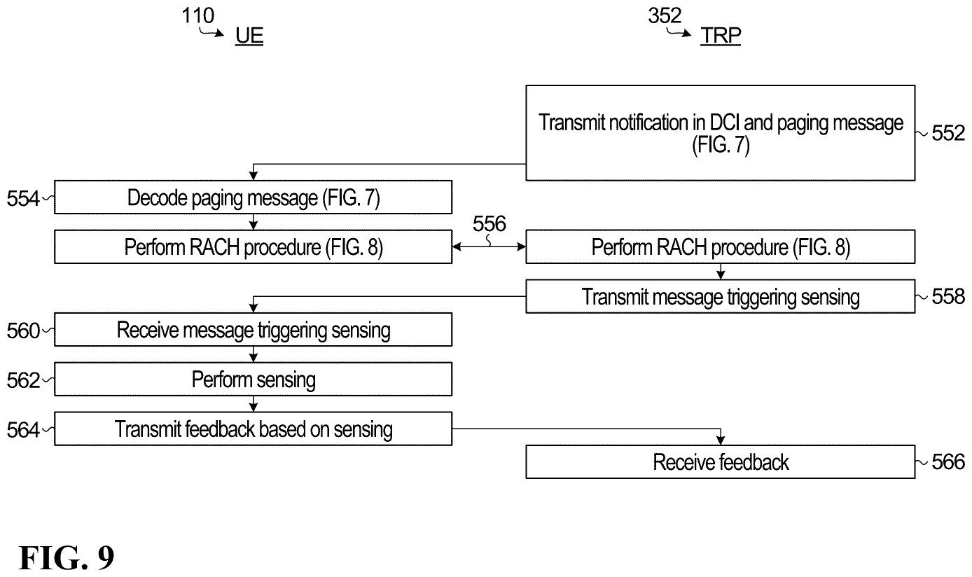

For example, FIG. 9 illustrates a method for triggering sensing when UE 110 is in a power-saving state, according to one embodiment. TRP 352 determines that UE 110 is required to perform sensing. In response, at step 552, TRP 352 pages UE 110 via the way described in relation to FIG. 7, e.g. during a monitoring occasion TRP 352 transmits downlink notification 484, which schedules paging message 486. The paging message 486 includes the individual ID for UE 110.

At step 554, the UE 110 decodes the paging message 486 and determines that it is being paged. At step 556, a RACH procedure is performed, e.g. via the method of FIG. 8. Upon completion of the RACH procedure, the UE 110 has transitioned from the power-saving state to a network connected state (e.g. from an RRC Inactive or RRC Idle state to an RRC connected state). At step 558, the TRP 352 transmits a message to the UE 110 triggering the UE 110 to perform sensing. The message may be transmitted in dynamic signaling (e.g. DCI) or semi-static signaling (e.g. RRC signaling). The message may also configure one or more parameters related to the sensing (e.g. signal the resources to be used by the UE 110 to transmit the sensing feedback). At step 560, the UE 110 receives the message. In response, at step 562, the UE 110 performs the sensing. At step 564, the UE 110 transmits feedback based on the sensing. At step 566, the TRP 352 receives the feedback.

However, in some scenarios the latency associated with the method of FIG. 9 may be unacceptable. The TRP 352 may require the sensed feedback from the UE 110 promptly, e.g. there may only be a small window of time between when the TRP 352 determines that the UE 110 is to perform sensing and when the UE 110 must start sensing to feedback the results of the sensing. Steps in FIG. 9 such as performing a RACH procedure prior to triggering sensing might introduce too much latency.

As one example, a manufacturing facility may be in the vicinity of the TRP 352, and the manufacturing facility may include autonomous robots that move to perform various activities. The TRP 352 may be required to track the location of the robots and send messages controlling the robots in response. Therefore, it may be necessary for the TRP 352 to track the location of the robots in real-time or near real-time. UEs, including UE 110, may be mounted on the walls and/or ceiling of the manufacturing facility and use radar to determine the location of moving robots. Upon the TRP 352 determining that the location of a robot has changed (e.g. due to a communication channel between the TRP 352 and the robot being lost or degraded), the TRP 352 may trigger the UEs to perform sensing by way of radar to obtain information about the new location of the robot. The TRP 352 may require the sensing to occur and feedback to be received promptly. Performing the RACH procedure prior to the UE 110 performing sensing may incur unacceptable latency.

In some embodiments below, methods are instead disclosed in which the indication triggering sensing is included as part of the paging information, e.g. in the DCI of the downlink notification 484 and/or in a message scheduled by the DCI in the downlink notification 484. Information configuring the sensing may also be included as part of the paging information.

### Triggering Sensing via Paging Information

In some embodiments, information transmitted by the TRP 352 that is related to paging may include an indication that is used for triggering the UE 110 to perform sensing. For example, as explained below, the indication may be in the DCI of the downlink notification 484, and/or in a message scheduled by the downlink notification 484.

When a UE 110 is triggered to perform sensing, the sensing proceeds according to certain parameters that need to be configured. The parameters will be referred to as “sensing parameters”. A non-exhaustive list of one or more sensing parameters that might need to be configured for a UE include (but are not limited to):
The type of sensing to be performed by the UE. For example, if the UE can perform multiple different types of sensing, the sensing to be performed needs to be indicated to the UE. In the case of RF sensing, certain specific parameters may need to be configured, such as whether the UE is to perform: (1) presence detection, e.g. to determine whether there is an object in the sensing area of UE 110, and/or (2) location detection, e.g. to determine the location of that object, and/or (3) Doppler estimation, e.g. to estimate the speed and direction of the object.
Resources for transmitting feedback obtained from the sensing. For example, there may be multiple time-frequency resources that could possibly be used for transmitting the sensing feedback, and the specific time-frequency resources to be used by the UE may need to be indicated. The specific time-frequency resources to be used may be indicated by an index. In some implementations, sensing feedback may be transmitted by the UE periodically, in which case periodic time-frequency resources may need to be indicated.
The time period for performing the sensing, e.g. when the sensing is to start and/or finish, and/or a duration of the sensing. In some implementations, the sensing may be periodic.
In the case of RF sensing, whether electromagnetic waves are to be transmitted from the UE (e.g. in the case of active sensing), and if so possibly the resources to be used by the UE for transmitting the electromagnetic waves. For example, there may be multiple time-frequency resources that could possibly be used for transmitting the electromagnetic waves, and the specific time-frequency resources to be used by the UE may need to be indicated. The specific time-frequency resources to be used may be indicated by an index.
In the case of RF sensing, the resources to be used by the UE for receiving the reflected electromagnetic waves. For example, there may be multiple time-frequency resources that could possibly be used for receiving the reflected electromagnetic waves, and the specific time-frequency resources to be used by the UE may need to be indicated. The specific time-frequency resources to be used may be indicated by an index.

In some embodiments, some or all of the sensing parameters listed above might be predetermined (e.g. pre-configured) in advance and therefore might not need to be configured when sensing is triggered. As one example, the resources to be used by the UE 110 to transmit sensing feedback may be pre-configured in advance, e.g. as grant-free uplink time-frequency resources. Also, some of all of the sensing parameters listed above might not be applicable for certain sensing scenarios, e.g. if the UE 110 is not performing RF sensing. Also, the sensing parameters to be configured might include other parameters that are not necessarily related to sensing directly, but possibly relate to network access and/or obtaining a timing advance (TA) value for the UE 110. For example, information configuring sensing parameters might include an indication of contention-free RACH resources for the UE 110 to perform a RACH procedure, e.g. so that the UE 110 can obtain a TA value for uplink synchronization to be used by the UE 110 for transmitting the sensing feedback. If the TA value does not change for a UE, e.g. the UE is static, then a RACH procedure might not be necessary.

If all of the sensing parameters are predetermined (e.g. pre-configured) in advance, then the indication in the paging information that triggers the UE 110 to perform the sensing might simply be one or more bits present in a field of DCI, or one or more bits present in a message scheduled by the DCI. For example, the indication may be one or more bits present in downlink notification 484, where downlink notification 484 may be a paging notification, e.g. having a CRC value scrambled by a paging-specific ID, such as a P-RNTI. As another example, the indication may be one or more bits present in paging message 486. If the indication is in the paging message 486, the indication may be associated with one or more UE IDs, thereby indicating that just those one or more UEs is/are to perform the sensing. Alternatively, the indication in the paging message 486 might not be associated with a UE ID, thereby indicating that all UEs in the paging group (e.g. all UEs sharing the P-RNTI) are to perform the sensing.

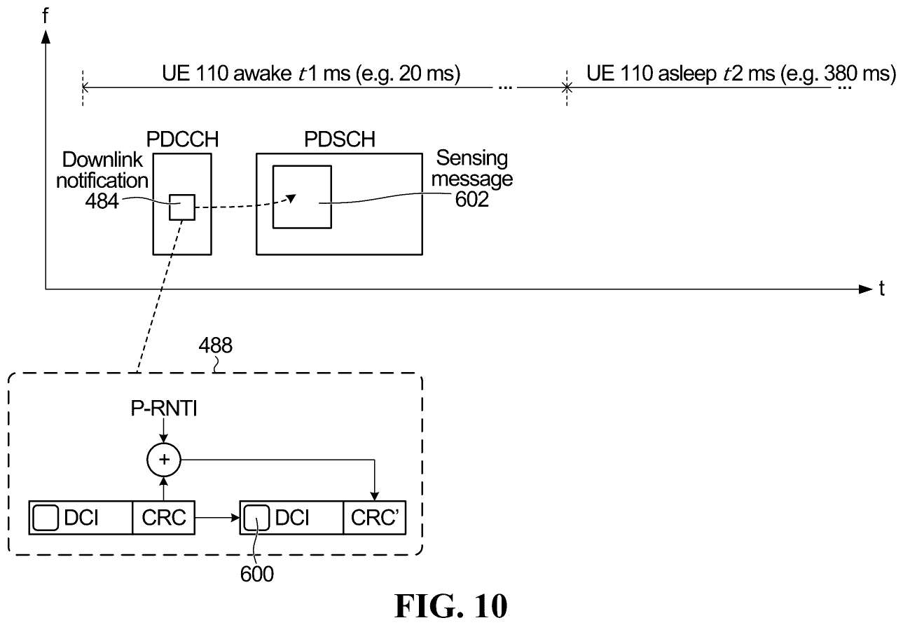

In some embodiments, one or more sensing parameters may be configured when triggering sensing. For example, FIG. 10 illustrates triggering sensing and configuring one or more sensing parameters, according to one embodiment. Like explained in relation to FIG. 7, in a wake-up duration of a power-saving state, UE 110 monitors for downlink notification 484, e.g. using blind detection. The downlink notification 484 is paging information in that it may be used to schedule a paging message. In the illustrated example, the downlink notification 484 has a CRC value that is scrambled by a P-RNTI. A field 600 in the DCI includes one or more bits that indicate, to the UE 110, that a sensing message 602 is being scheduled by the DCI, e.g. instead of paging message 486. Based on the information in the DCI, the UE 110 decodes the sensing message 602 in the PDSCH. The sensing message 602 includes an indication of one or more sensing parameters that are configured for performing the sensing. The presence of a particular bit value in field 600 in the DCI may be the indication that triggers the UE 110 to perform sensing, and the sensing message 602 provides an indication of one or more sensing parameters for performing the sensing. The UE 110 may then start performing sensing right away after decoding the sensing message 602, e.g. without the need for a RACH procedure to transition to a connected state. However, depending upon the implementation, before the UE 110 starts sensing the UE 110 may need to check the sensing message 602 to confirm its UE ID (or its UE group ID) is present, e.g. if the sensing message 602 instructs only certain UEs to perform sensing.

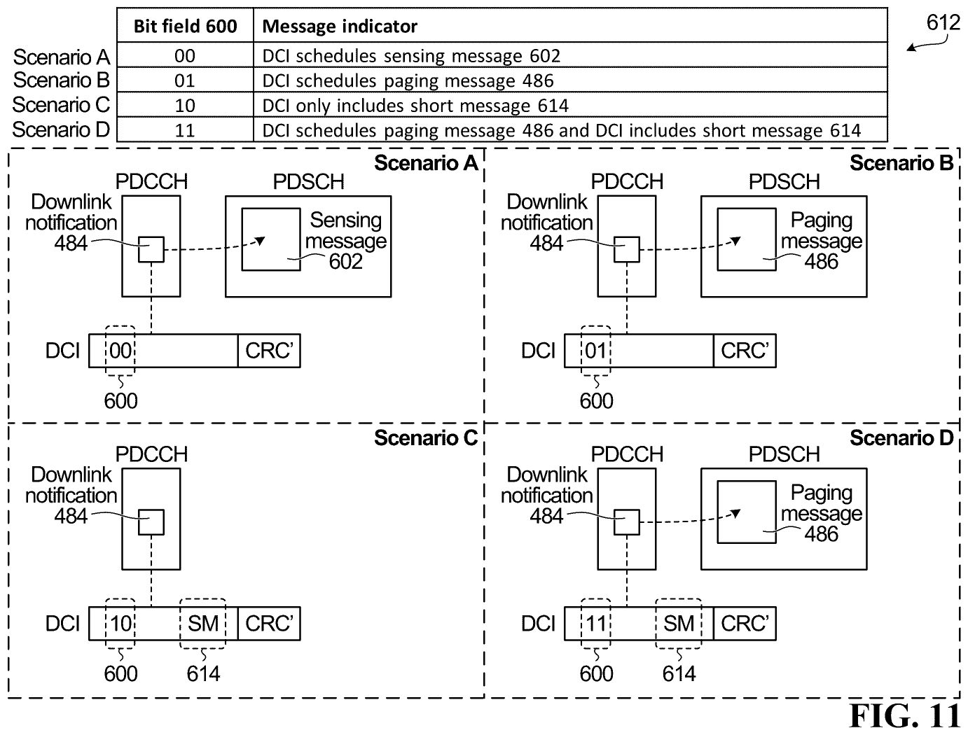

FIG. 11 illustrates values of field 600 in downlink notification 484, according to one embodiment. As shown in table 612, field 600 can be one of four bit values: 00, 01, 10, and 11. Each bit value is a pattern of bits that indicates a respective different scenario. A bit value of 00 (“Scenario A”) indicates to the UE 110 that sensing is being triggered and that a sensing message 602 is being scheduled instead of a paging message 486. A bit value of 01 (“Scenario B”) indicates to the UE 110 that paging message 486 is being scheduled. A bit value of 10 (“Scenario C”) indicates to the UE 110 that the DCI includes a short message (“SM”) 614 and that no message is being scheduled in the PDSCH. A bit value of 11 (“Scenario D”) indicates to the UE 110 that the DCI is scheduling a paging message 486, but also includes a short message 614. Therefore, in each paging occasion, the TRP 352 can using the paging information, as needed, to perform one of several actions, e.g. schedule a paging message 486, or trigger sensing and schedule a sensing message 602 providing a configuration of sensing parameters, or provide a short message 614 (which might or might not relate to sensing), etc. In one implementation, field 600 may be a field that was previously utilized just for indicating short messages, e.g. the field is modified to accommodate both indicating short messages and indicating the scheduling of a sensing message 602.

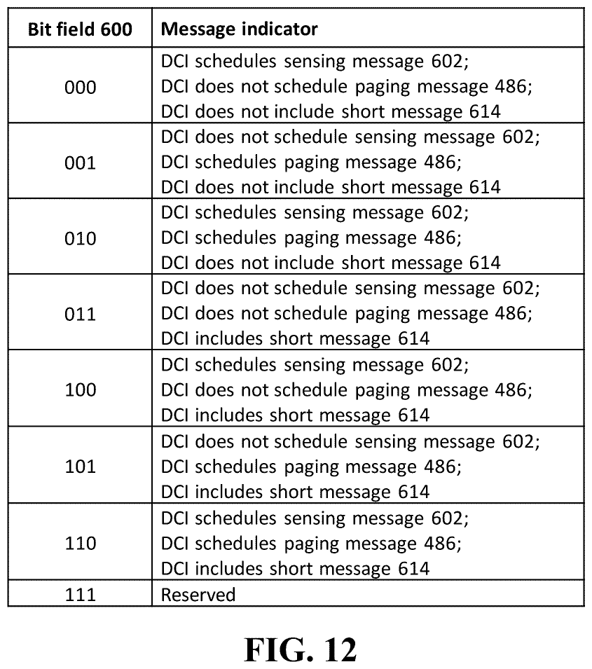

FIG. 12 illustrates values of field 600 in downlink notification 484, according to another embodiment. The field 600 is three bits long and therefore may take on one of eight different bit values. Each bit value is a pattern of bits that indicates a respective different scenario. For example, bit value 000 indicates that: (1) the DCI schedules sensing message 602, (2) the DCI does not schedule a paging message 486, (3) and the DCI does not include a short message 614. The example in FIG. 12 allows for the DCI to schedule both a paging message 486 and a sensing message 602, which occurs when bit field 600 has the bit value 010 or 110.

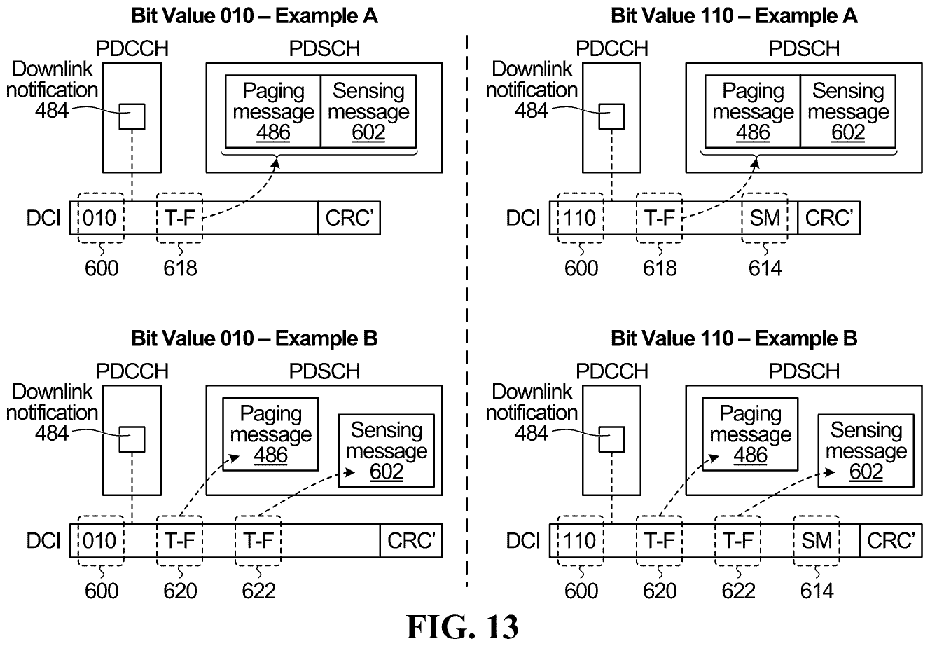

FIG. 13 illustrates two example ways in which both a paging message 486 and a sensing message 602 may be scheduled by a same DCI in a downlink notification 484. The left side of the figure corresponds to the field 600 having bit value 010, and the right side of the figure corresponds to the field 600 having bit value 110. In Example A, the DCI includes scheduling information for single allocation of data, e.g. a single codeword. For example, the DCI includes scheduling information 618 for a single set of time-frequency (“T-F”) resources in the PDSCH. The time-frequency resources include both the paging message 486 and the sensing message 602, e.g. perhaps encoded as a single codeword and/or concatenated. The UE 110 is configured (e.g. in advance) to know which bits relate to the paging message 486 and which bits relate to the sensing message 602. In Example B, the DCI instead includes two sets of scheduling information, one for scheduling the paging message 486 and another for scheduling the sensing message 602. For example, the DCI may include scheduling information 620 for a first set of time-frequency resources for the paging message 486 and additional scheduling information 622 for a second set of time-frequency resources for the sensing message 602. The benefit of Example B compared to Example A is that the paging message 486 and sensing message 602 may be independently scheduled at different time-frequency resources, and/or may possibly have different modulation and coding schemes (MCS) or different other parameters indicated in the DCI. The drawback of Example B compared to Example A is the DCI format in Example B typically has more bits, which may be a waste of overhead, especially if the DCI is only occasionally used to schedule both a paging message and a sensing message at the same time.

The benefit of the embodiment described in relation to FIGS. 12 and 13 compared to the embodiment described in relation to FIG. 11 is that the embodiment described in relation to FIGS. 12 and 13 allows for more flexibility, but the drawback is a possibly longer DCI, which introduces more overhead.

The sensing message 602 may include sensing parameters that the TRP 352 configures for the sensing, e.g. as explained earlier. Additionally, or instead, the sensing message 602 may indicate which UEs are to perform the sensing, e.g. if the paging information relates to a group of UEs (e.g. the P-RNTI is a group ID), and only certain UEs are to perform sensing.

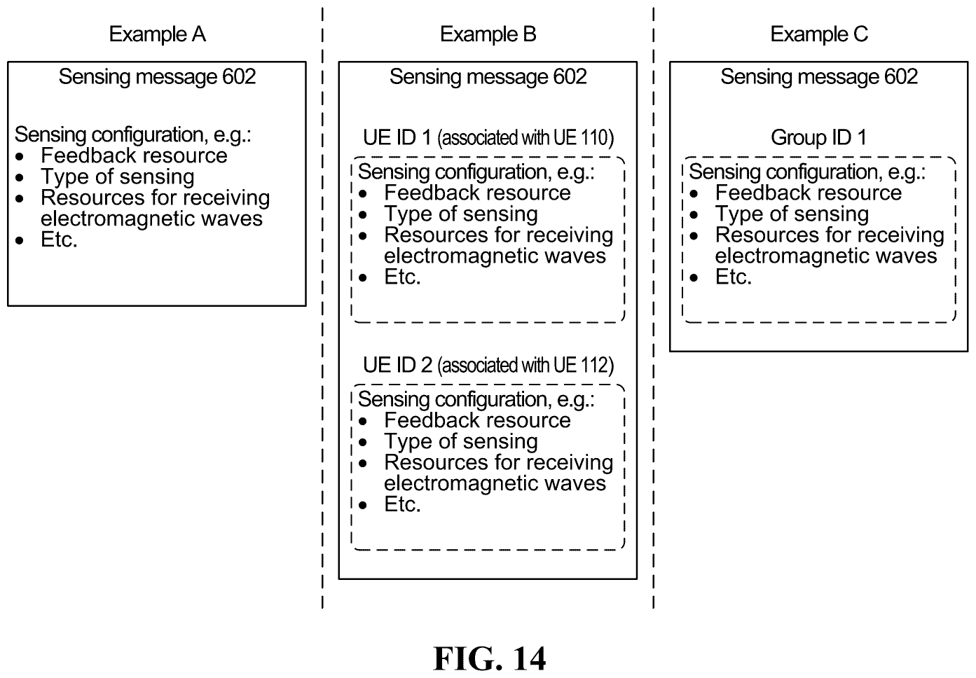

FIG. 14 illustrates a few different examples of possible formats for sensing message 602. In Example A, the sensing message 602 does not include a UE ID. This may be the case in two different scenarios. The first scenario is when the downlink notification 484 is UE-specific, e.g. the P-RNTI is UE-specific, rather than being shared by a group of UEs. In this scenario, the sensing message 602 is also UE-specific, e.g. because the sensing message 602 was scheduled using DCI that has a CRC value scrambled using a UE-specific ID (e.g. a UE-specific P-RNTI). Therefore, the sensing message 602 does not have to include the UE ID. The second scenario is when the downlink notification 484 is for a group of UEs, e.g. the P-RNTI is a group ID, and the contents of the sensing message 602 apply to all of the UEs in the group. In Example A, the sensing message 602 configures one or more sensing parameters to be used for the sensing, e.g. the resources used by the UE to transmit the feedback obtained from the sensing, and/or the type of sensing performed, etc.

In Example B of FIG. 14, the sensing message 602 is a group sensing message, e.g. applies to a group of UEs sharing a common P-RNTI. For example, the P-RNTI that scrambles the CRC value of the DCI of the downlink notification 484 is a group ID shared by all UEs in that group. The group might be all UEs served by the TRP 352, depending upon the implementation. The sensing message 602 indicates which one or more UEs in the group are specifically being instructed to perform sensing, e.g. by the presence of one or more UE IDs in the sensing message 602. In the illustrated example, both UE 110 and UE 112 in the group are the UEs being instructed to perform sensing because the sensing message 602 includes UE ID 1, which uniquely identifies UE 110, and the sensing message 602 also includes UE ID 2, which uniquely identifies UE 112. For each UE identified, the sensing message 602 configures one or more sensing parameters to be used by that UE for the sensing. The illustrated example shows separate sensing parameters being configured for both UE 110 and UE 112. However, in a variation, if the configured sensing parameters are the same for multiple UEs, the sensing message 602 may include an indication of the configured sensing parameters, along with an indication of the UEs to which the configured sensing parameters apply.

In Example C of FIG. 14, the sensing message 602 is shared by multiple groups of UEs. For example, all UEs served by the TRP 352 may be separated into different groups, each associated with a respective different Group ID. However, all UEs may monitor for the same downlink notification 484. The DCI of the downlink notification 484 may have a CRC value that is scrambled by a P-RNTI that is common to all the UEs. The sensing message 602 indicates which one or more UE groups are being instructed to perform sensing, e.g. by the presence of one or more Group IDs in the sensing message 602. In the illustrated example, a group of UEs associated with Group ID 1 are being triggered to perform sensing because the sensing message 602 includes Group ID 1. For each group identified, the sensing message 602 configures one or more sensing parameters to be used by the UEs of the group for the sensing. Although not illustrated, if the configured sensing parameters are the same for more than one group of UEs, the sensing message 602 may include an indication of the configured sensing parameters, along with an indication of the UE groups to which the configured sensing parameters apply.

FIG. 14 illustrates specific example sensing parameters being configured by the sensing message 602, e.g. “feedback resources”, “type of sensing”, etc. There are different possible types of sensing parameters that may be configured, e.g. as described earlier. Alternatively, one or more of the sensing parameters may be predetermined (e.g. pre-configured) in advance and therefore do not need to be signaled in the sensing message 602.

In one example of sensing message 602, one or more of the following may be included in the sensing message 602:
A UE identity, an example of which is UE ID 1 in Example B of FIG. 14. In some embodiments, the UE identity may be a temporary mobile subscriber identity (TMSI), e.g. if the UE is in an RRC Idle state. In other embodiments, the UE identity may be an inactive-RNTI (I-RNTI), e.g. if the UE is in an RRC Inactive state.
A group UE identity, such as a group RNTI, an example of which is Group ID 1 in Example C of FIG. 14. The group ID may be configured by the TRP 352 for a group of UEs that are to collaboratively perform sensing. In some embodiments, the group ID may be a group RNTI for a group of UEs in an RRC Inactive state.
An indication of sensing feedback resources, which is an example of a sensing parameter specifying which resources are to be used by the UE(s) to send, to the TRP 352, feedback obtained from the sensing. In some implementations, sensing feedback may be transmitted periodically.
An indication of the type of sensing to be performed, which is an example of a sensing parameter specifying which type of sensing the UE(s) is to perform, e.g. presence detection versus location detection versus Doppler estimation, etc.
An indication of the time period for performing the sensing, which is an example of a sensing parameters specifying the sensing time, e.g. when the sensing is to start and/or finish, and/or a duration of the sensing, etc. In some implementations, the sensing may be periodic.
One or more other sensing parameters that may be specific to RF sensing, e.g. whether electromagnetic waves are to be transmitted from the UE (e.g. in the case of active sensing), and/or the resources to be used by the UE for transmitting the electromagnetic waves, and/or the resources to be used by the UE for receiving the reflected electromagnetic waves.
An indication of resources to be used by the UE(s) for performing a contention-free RACH procedure, e.g. an indication of a preamble and/or a time-frequency location for performing a RACH procedure. The RACH may then be performed before, during, or after the sensing, depending upon the implementation. By performing the RACH procedure, the UE(s) may, for example, obtain a TA value to use for uplink synchronization when transmitting the sensing feedback to the TRP 352. If the TA value does not change for a UE, e.g. the UE is static, then a RACH procedure might not be necessary.

The embodiments described in relation to FIGS. 10 to 14 assume that sensing parameters are provided in a sensing message 602 scheduled in a data channel. In a variation, one or more sensing parameters may be present in the DCI of the downlink notification 484, e.g. in the short message 614, in which case a sensing message 602 might not need to be scheduled. In another variation, the sensing message 602 may be present in a control channel, e.g. in the second stage of a two-stage DCI. The downlink notification 484 may indicate if sensing message 602 is in DCI at another time-frequency resource, and the downlink notification 484 may possibly schedule that other time-frequency resource.

### Sensing Configuration Updates

There may be situations in which a configuration related to sensing is updated. For example, a particular sensing parameter may be pre-configured and therefore not indicated in a sensing message 602, but that pre-configured sensing parameter may be updated on a semi-static basis. For example, the UE 110 may use a particular carrier to perform sensing, e.g. to transmit and/or receive electromagnetic waves. The carrier might not be configured in sensing message 602 because it is pre-configured in advance. However, the carrier may occasionally need to be changed, e.g. to reduce overhead or to increase resolution of the sensing. As another example, the UE 110 may use one time-frequency resource from a set of time-frequency resources for transmitting and/or receiving electromagnetic waves. The sensing message 602 may include an index indicating the particular time-frequency from the set that is to be used for a particular instance of sensing. However, occasionally the TRP 352 may need to modify the set of time-frequency resources.

Therefore, there may be occasions when a configuration related to sensing, e.g. a configuration update, needs to be provided to a particular UE, or to a group of UEs, or possibly to all UEs served by the TRP 352. The configuration related to sensing will be referred to as a “sensing configuration”. The sensing configuration is different from the sensing message 602 because it does not trigger sensing and typically provides a sensing configuration that would only change on a semi-static basis and would not be indicated in a sensing message 602.

When a sensing configuration needs to be provided to one or more UEs, those one or more UEs may be in a power-saving state, such as an RRC Idle or RRC Inactive state.

When one or more UEs are in a power-saving state, one method to provide the sensing configuration on a cell-specific basis (e.g. for all UEs served by the TRP 352) is to include the sensing configuration in system information, such as in a system information block (SIB). In some implementations, when any system information in a SIB changes, a bit in a short message in the downlink notification (e.g. in downlink notification 484) may indicate that system information has been modified, but not indicate what system information has been modified. For example, a “SystemInfoModification” bit in the DCI of a paging notification may be set. In such a situation, every time the DCI includes an indication that system information has been modified, each UE may need to check all SIBs to see if the sensing configuration has changed. If it is other system information that has changed, and there is no sensing configuration update, then the UE's power spent checking for an updated sensing configuration may be wasted.

When one or more UEs are in a power-saving state, one method to provide the sensing configuration on a UE-specific basis is to page the UE (like explained in relation to FIG. 7), and then perform a RACH procedure (e.g. such as the one explained in relation to FIG. 8) to cause the UE to enter a connected state (e.g. an RRC Connected state). A reconfiguration in RRC signaling may then be used to provide the sensing configuration. After the reconfiguration, e.g. after expiry of a timer, the UE then reverts back to the power-saving state. However, UE power may be wasted performing the RACH procedure and entering the connected state just to obtain a sensing configuration.

Instead, in some embodiments, the information related to paging may include an indication that a configuration related to sensing has changed. For example, the indication may be in the DCI of the downlink notification 484 (e.g. a bit in the DCI, such as a “SensingInfoModification” bit), and/or the indication may be in a message scheduled by the downlink notification 484. The message scheduled by the downlink notification 484 may be a paging message, e.g. the indication may be one or more bits in a paging message. Moreover, in some embodiments, the DCI of the downlink notification 484 and/or a message scheduled by the downlink notification 484 may itself carry the sensing configuration. If the sensing configuration is carried in a message scheduled by the DCI of the downlink notification 484, the sensing configuration might be in a paging message or in a dedicated sensing configuration message, such as sensing configuration 702 described below.

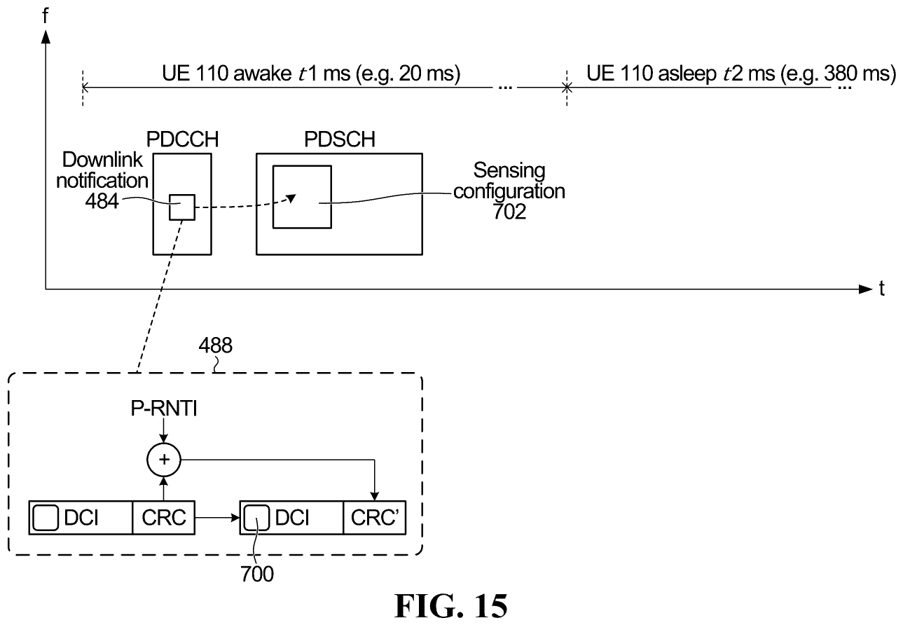

FIG. 15 illustrates an example way to indicate that a configuration related to sensing has changed and provide a sensing configuration, according to one embodiment. The sensing configuration may be an updated sensing configuration, e.g. it may provide an updated configuration that modifies a current sensing configuration. Like explained in relation to FIG. 7, in a wake-up duration of a power-saving state, UE 110 monitors for downlink notification 484, e.g. using blind detection. The downlink notification 484 is paging information in that it may be used to schedule a paging message. In the illustrated example, the downlink notification 484 has a CRC value that is scrambled by a P-RNTI. A field 700 in the DCI includes one or more bits that indicate, to the UE 110, that a message providing a sensing configuration 702 is being scheduled by the DCI. Based on the information in the DCI, the UE 110 decodes the sensing configuration 702 in the PDSCH. The indication that the DCI is scheduling a sensing configuration 702 (e.g. the indication in field 700) may itself act as the indication that a configuration related to the sensing has changed, and the changed configuration may be provided in the scheduled sensing configuration 702. However, in some embodiments, the UE 110 checks the sensing configuration 702 to confirm whether the changed configuration applies to UE 110, e.g. by searching in the sensing configuration 702 for an ID that is specific to the UE or to a group of UEs that includes the UE 110.

The following is a non-exhaustive list of one or more configurations that may be provided in sensing configuration 702:
The resources used for transmitting feedback based on the sensing. For example, the sensing message 602 described earlier may indicate which particular resources in a set of resources are used for a particular instance of sensing. However, the sensing configuration 702 may establish or update the set of resources, e.g. to reduce, expand, or change the set of resources for transmitting feedback.
The resources used for performing sensing. For example, the sensing message 602 described earlier may indicate which particular resources in a set of resources are used for a particular instance of sensing (e.g. for transmitting and/or receiving electromagnetic waves). However, the sensing configuration 702 may establish or update the set of resources, e.g. to reduce, expand, or change the set resources for sensing.
The signal(s) used to perform sensing, e.g. the type and/or properties of the signal(s). In some cases, a communication signal may be reused as a signal to perform sensing.
The carrier used for transmitting feedback, and/or the carrier used for performing the sensing. In some cases, the sensing message 602 described earlier may indicate which particular carrier is used from a set of possible carries, but the sensing configuration 702 establishes or updates the set of carriers.

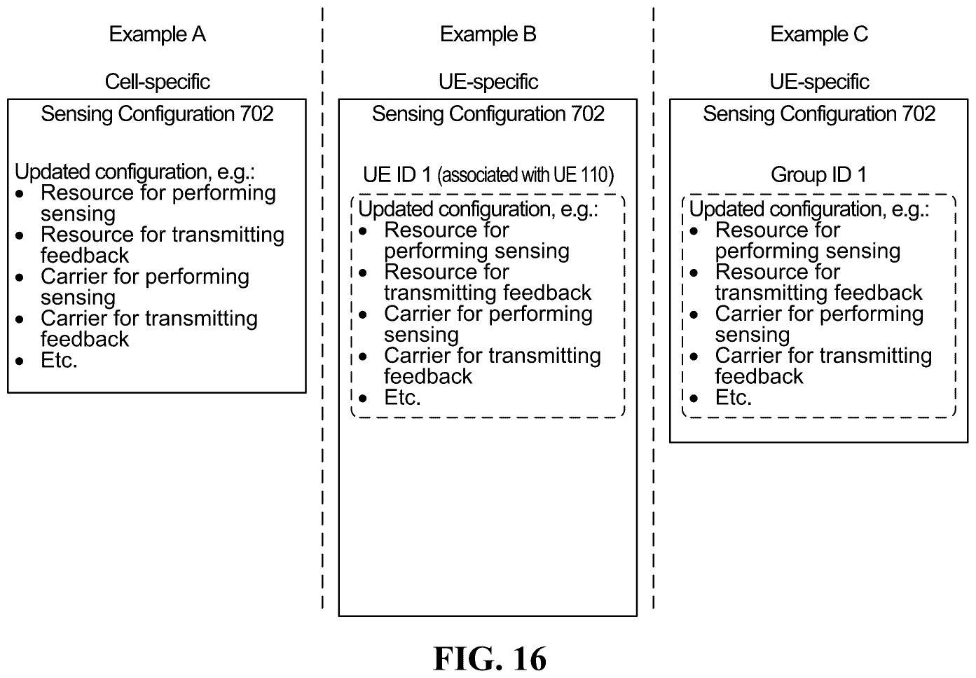

FIG. 16 illustrates a few different examples of possible formats for sensing configuration 702. In Example A, the sensing configuration 702 is cell-specific, e.g. it applies to all UEs served by TRP 352 that perform sensing. No UE ID is included in the sensing configuration 702 because the sensing configuration 702 is cell-specific.

In Example B of FIG. 16, the sensing configuration 702 is UE-specific. The sensing configuration 702 indicates one or more UE IDs and the updated configuration being applied to each UE. In the illustrated example, the sensing configuration only applies to UE 110 because of the presence of UE ID 1, which uniquely identifies UE 110. Although not illustrated, the sensing configuration may apply to multiple UEs by including, in sensing configuration 702, the UE ID of each UE to which the sensing configuration applies. Also, although not illustrated, different UEs may have different sensing configuration updates, e.g. by the sensing configuration 702 including, for each different UE, an ID uniquely identifying that UE and associated sensing configuration update. A UE ID may be a TMSI (e.g. if the UE is in an RRC Idle state) or an I-RNTI (e.g. if the UE is in an RRC Inactive state).

In Example C of FIG. 16, the sensing configuration 702 is also UE-specific (not cell-specific), but it is specific to a group of UEs, e.g. a group of UEs in an RRC Inactive state having an associated Group ID. The sensing configuration 702 indicates one or more Group IDs and the updated configuration being applied to each group. In the illustrated example, the sensing configuration only applies to the group of UEs identified by Group ID 1. Although not illustrated, the sensing configuration may apply to multiple groups of UEs by including, in sensing configuration 702, the Group ID of each group to which the sensing configuration applies. Also, although not illustrated, different groups may have different sensing configuration updates, e.g. by the sensing configuration 702 including, for each different UE group, a group ID uniquely identifying that group and associated sensing configuration update.

Whether the sensing configuration 702 is cell-specific or UE-specific, the DCI in the downlink notification 484 may have different possible formats for accommodating the scheduling of a sensing configuration 702. For example, the DCI format may be analogous to that shown in FIG. 11 in which a field in DCI is used to indicate whether sensing configuration 702 or a paging message 486 is being scheduled, and a single DCI cannot schedule both a sensing configuration 702 and a paging message 486. The DCI may have its CRC value scrambled by a paging ID (e.g. a P-RNTI). In another example, the DCI format may be analogous to that shown in FIGS. 12 and 13 in which the DCI may be able to schedule both a sensing configuration 702 and a paging message 486.

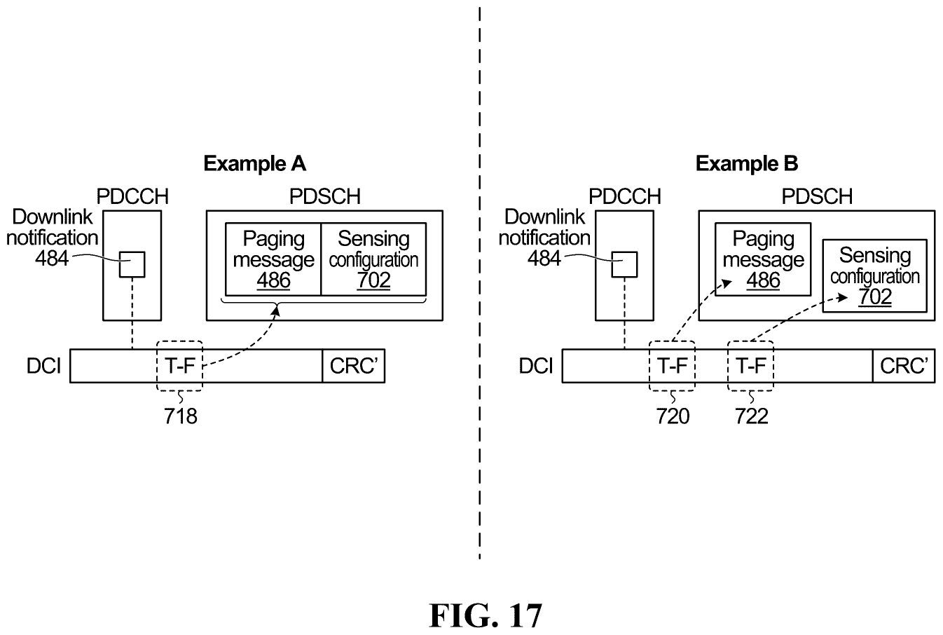

FIG. 17 illustrates two example ways in which both a paging message 486 and a sensing configuration 702 may be scheduled by a same DCI in a downlink notification 484. In Example A, the DCI includes scheduling information for single allocation of data, e.g. a single codeword. For example, the DCI includes scheduling information 718 for a single set of time-frequency (“T-F”) resources in the PDSCH. The time-frequency resources include both the paging message 486 and the sensing configuration 702, e.g. perhaps encoded as a single codeword and/or concatenated. The UE 110 is configured (e.g. in advance) to know which bits relate to the paging message 486 and which bits relate to the sensing configuration 702. In Example B, the DCI instead includes two sets of scheduling information, one for scheduling the paging message 486 and another for scheduling the sensing configuration 702. For example, the DCI may include scheduling information 720 for a first set of time-frequency resources for the paging message 486 and additional scheduling information 722 for a second set of time-frequency resources for the sensing configuration 702. The benefit of Example B compared to Example A is that the paging message 486 and sensing configuration 702 may be independently scheduled at different time-frequency resources, and/or may possibly have a different MCS or different other parameters indicated in the DCI. The drawback of Example B compared to Example A is the DCI format in Example B typically has more bits, which may be a waste of overhead, especially if the DCI is only occasionally used to schedule both a paging message 486 and a sensing configuration 702 at the same time.

Different variations are possible. For example, in some embodiments, for a cell-specific sensing configuration update, a bit in the DCI of the downlink notification 484 may indicate that there is a sensing configuration update for the UEs. The sensing configuration update may be scheduled by the DCI (e.g. like in FIG. 15), or the sensing configuration update may be included in system information, e.g. in a SIB. As another example, in some embodiments, a bit in paging message 486 may indicate that there is a sensing configuration update. The update may be cell-specific (e.g. not-associated with a UE ID) or UE-specific (e.g. associated with a UE ID). The updated configuration might be included in the paging message 486 or somewhere else, e.g. in a SIB.

In some embodiments, the initial sensing configuration may be provided in system information (e.g. in a SIB), and the sensing configuration 702 only provides an updated sensing configuration. In other embodiments, the sensing configuration 702 also provides the initial configuration, e.g. there is no sensing configuration information in system information. However, for a UE that is not in a power-saving state, e.g. for a UE that is in an RRC connected state, a sensing configuration might need to be provided in a way different than via paging information because the UE might not be monitoring for paging.

### Other Variations and Example Methods

Independent of all the embodiments described earlier, in some implementations the TRP 352 may be able to indicate that one or more UEs do not need to decode information related to paging at a particular paging occasion, e.g. by the TRP 352 transmitting a sequence that has a particular detected power pattern. For example, in advance of a PDCCH of a paging monitoring occasion, the TRP 352 may transmit a particular predefined sequence having a particular power that is detected by the UE. The detected power may indicate, to the UE, that it is the predefined sequence, which may indicate to the UE that the upcoming paging information does not include any paging, sensing trigger, or sensing configuration for the UE. The UE may then refrain from decoding the paging information, thereby saving power. For example, the UE may refrain from performing blind detection to try to decode a downlink notification 484, and the UE may even avoid turning on its RF circuitry.

In most of the embodiments described above, the indication triggering the UE to perform sensing and/or the indication that a configuration related to sensing has changed, are included in information related to paging, e.g. in the DCI of a downlink notification (such as a paging notification) that may be used to schedule a paging message, and/or in a message scheduled by such DCI. However, the indication triggering the UE to perform sensing and/or the indication that a configuration related to sensing has changed does not necessarily need to be provided as part of paging information. For example, the UE in a power saving state may be configured to monitor resources in a control channel for a DCI providing or scheduling such information.

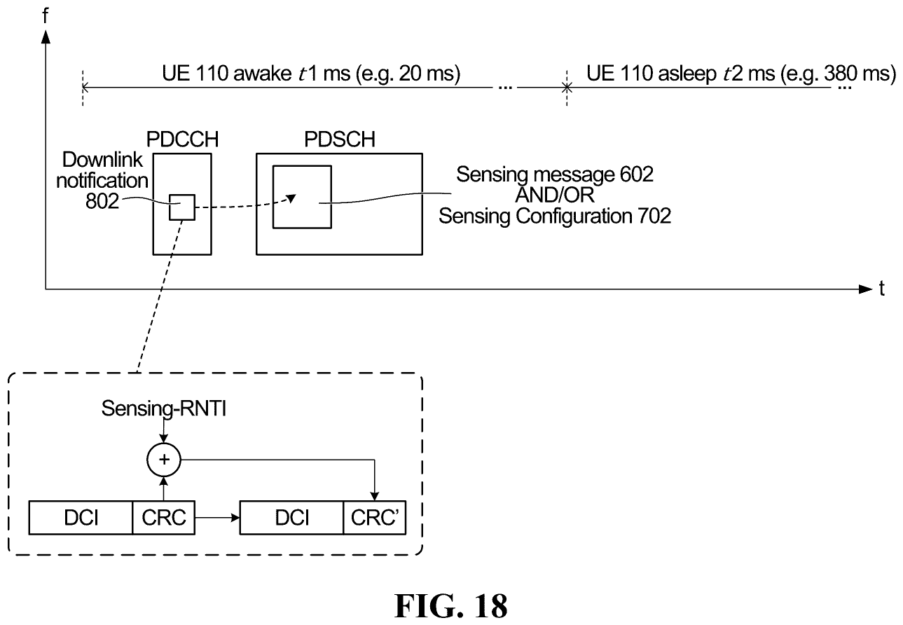

FIG. 18 illustrates triggering a UE in a power-saving state to perform sensing and/or indicating to the UE that a configuration related to sensing has changed, according to one embodiment. During a wake-up duration of a power-saving state, UE 110 searches for a downlink notification 802 related to sensing, e.g. via blind detection. In the illustrated example, the downlink notification 802 includes DCI having a CRC value scrambled by an ID that is specific to sensing, which is illustrated as being a “sensing-RNTI”. The sensing-RNTI may be configured by the TRP 352 and may be UE-specific or shared by a group of UEs. The blind detection may operate as follows: for each PDCCH candidate (search space), the UE 110 attempts to decode the DCI carried by the PDCCH candidate, unscrambles the CRC value of the DCI using the sensing-RNTI, and checks if the CRC value is valid. If the CRC value is not valid, the UE 110 assumes there is no sensing trigger or sensing configuration for the UE 110 in that PDCCH candidate. If the CRC value is valid, the UE assumes the decoded DCI of the PDCCH candidate is correct and carries the sensing-specific downlink notification 802. The monitoring occasions/search spaces for blind detecting the sensing-specific downlink notification 802 may be configured by the TRP 352, e.g. the TRP 352 may configure the monitoring symbols and frequency locations.

In some embodiments, the DCI of the downlink notification 802 may trigger sensing and/or indicate that there is a sensing configuration update. In some embodiments, the DCI may schedule a sensing message 602 and/or a sensing configuration 702, e.g. in a PDSCH as illustrated in FIG. 18. The downlink notification 802 may be signaling dedicated to sensing and have no relation to paging. The UE 110 may separately perform blind detection to also search for a paging notification, e.g. in a different search space or in the same search space as downlink notification 802.

All of the variations discussed earlier in relation to paging information may generally apply to FIG. 18. For example, the DCI of the downlink notification 802 may include a field indicating whether a sensing message 602 is scheduled, or whether a sensing configuration 702 is scheduled, or whether both are scheduled. If both are scheduled, they may be jointly scheduled together (e.g. like Example A of FIG. 17 but replacing the paging message 486 with the sensing message 602), or they may be independently scheduled in the same DCI (e.g. like Example B of FIG. 17 but replacing the paging message 486 with the sensing message 602). As another example, a sensing message 602 scheduled in the embodiment of FIG. 18 may have the same format as any of the examples in FIG. 14. As another example, a sensing configuration 702 scheduled in the embodiment of FIG. 18 may have the same format as any of the examples in FIG. 16. In one implementation, if the sensing-RNTI is UE-specific, then there is no UE ID in the DCI and/or in the sensing message 602 or sensing configuration 702 because the sensing trigger/configuration is only for that UE. Whereas, if the sensing-RNTI is not UE-specific (e.g. is shared by all UEs served by the TRP 352 that perform sensing), then the DCI and/or the sensing message 602 or sensing configuration 702 may include an ID indicating the UE or UEs to which the sensing trigger or sensing configuration applies. The ID may be associated with a single UE or be a UE group ID associated with a group of UEs.

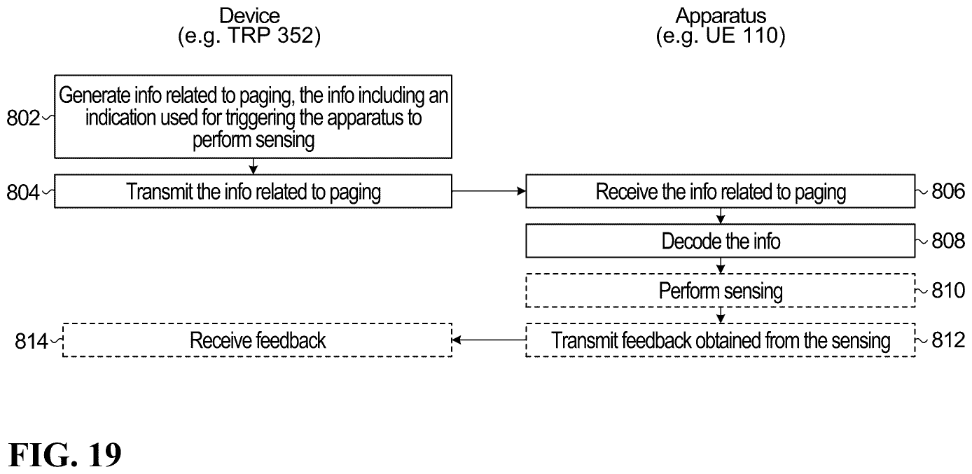

FIG. 19 illustrates a method performed by a device and an apparatus, according to one embodiment. The device may be a network device, e.g. a TRP 352, although not necessarily. The apparatus may be an ED 110, e.g. a UE, although not necessarily.

At step 802, the device generates information related to paging. In some embodiments, the information related to paging may be DCI, e.g. the downlink notification 484 described in any of the earlier embodiments. The information related to paging may also or instead be a message scheduled by DCI. One example of such a message is the paging message 486 described in any of the earlier embodiments. Another example of such a message is the sensing message 602 described in any of the earlier embodiments. The information related to paging includes an indication used for triggering the apparatus to perform sensing. A non-exhaustive list of examples of such an indication include: one or more bits in DCI (e.g. in downlink notification 484); and/or one or more bits in a message scheduled by the DCI (e.g. in paging message 486 or in sensing message 602); and/or a particular bit pattern in field 600 described earlier in relation to FIGS. 10-13; and/or a UE ID or Group ID present in a sensing message 602, e.g. the presence of an ID in Example B or C of FIG. 14 associated with a UE that thereby causes/instruct the UE to perform sensing.

The way in which the device generates the information related to paging depends upon the implementation. In one implementation, a series of bits including the indication are encoded using an encoding algorithm, e.g. using polar coding or an LDPC code, etc. The encoded codeword is then output for the transmitter to transmit, e.g. as DCI or as a message in a data channel.

At step 804, the device transmits the information related to paging. At step 806, the apparatus receives the information related to paging. At step 808, the apparatus decodes the information related to paging, e.g. via any one of the decoding methods described earlier. The indication in the information related to paging triggers the apparatus to perform sensing.

The remaining steps of FIG. 19 are optional because they might not be part of the method, e.g. they may be performed at a later time. At step 810, the apparatus performs the sensing. One example of sensing is the apparatus sensing electromagnetic waves reflected from at least one object. Another example of sensing is a sensor on the apparatus sensing a parameter. At step 812, the apparatus transmits feedback obtained from the sensing, and at step 814 the device receives the feedback. The feedback obtained from the sensing may comprise a parameter directly measured by the sensing and/or information derived from the sensing.

By performing the method of FIG. 19, the device may be able to more promptly trigger the apparatus to perform sensing because the triggering may occur via the indication included in the paging information. The apparatus does not need to first perform a RACH procedure to connect to the network.

Any of the variations described earlier, e.g. in relation to FIGS. 10 to 14, may be incorporated into the method of FIG. 19 described above. Some examples are below.

In some embodiments, the information related to paging comprises DCI, and the indication is in the DCI. An example of such DCI is that in downlink notification 484 described in relation to any one of FIGS. 10 to 13. Any of the examples explained in relation to FIGS. 10 to 13 may be incorporated into the method of FIG. 19. In some embodiments, the DCI has a CRC value that is scrambled by a paging identifier, e.g. by a P-RNTI (as is the case, for example, in FIGS. 10-13).

In some embodiments, a sensing message is scheduled by the DCI. In some such embodiments, the indication in the DCI indicates that the sensing message is being scheduled by the DCI. An example of a sensing message is any sensing message 602 described earlier, e.g. in relation to FIGS. 10 to 14. Any example sensing message 602 described earlier may be incorporated into the method of FIG. 19. In some embodiments, the sensing message may configure at least one of: the type of sensing to be performed by the apparatus; whether electromagnetic waves are to be transmitted from the apparatus; resources for transmitting the electromagnetic waves; resources for receiving the electromagnetic waves; resources for performing random access; or resources for transmitting feedback obtained from the sensing. Some examples of sensing parameters that may be configured by a sensing message are illustrated in FIG. 14. Any of the examples in FIG. 14 may be incorporated into the method of FIG. 19.

In some embodiments, the sensing message includes an ID that is specific to the apparatus or to a group of apparatuses including the apparatus, and a configuration provided by the sensing message applies to the apparatus or to the group of apparatuses associated with the ID. Two examples are shown in Example B and Example C of FIG. 14. In Example B, the ID is a UE ID specific to one UE. In Example C, the ID is a Group ID specific to a group of UEs.

In some embodiments, the indication in the paging information comprises a pattern of one or more bits in DCI. Example patterns of bits in a DCI include those shown in the tables in FIGS. 11 and 12. The examples in FIGS. 11 and 12 may be incorporated into the method of FIG. 19. In one example, the pattern of one or more bits also indicates that a paging message is being scheduled by the DCI, an example of which is bit values 010 and 110 of field 600 in FIGS. 12 and 13.

In some embodiments, the indication is a first indication, the information related to paging is first information, and the method of FIG. 19 further includes generating second information related to paging. For example, the second information may be DCI and/or a message scheduled by the DCI. The DCI may be associated with (e.g. transmitted by the TRP 352 at) a later paging occasion compared to the transmission in step 804. The second information may include a second indication. The second indication may be used for indicating that a configuration related to the sensing has changed. The method of FIG. 19 may further include the device transmitting the second information and the apparatus receiving and decoding the second information.

A non-exhaustive list of examples of the second indication include: one or more bits in DCI (e.g. in downlink notification 484); and/or one or more bits in a message scheduled by the DCI (e.g. in paging message 486 or in sensing configuration 702); and/or a particular bit pattern in field 700 described earlier in relation to FIGS. 15; and/or a UE ID or Group ID present in a sensing configuration 702, e.g. the presence of an ID in Example B or C of FIG. 16 associated with a UE. The examples in FIGS. 15 and 16 may be incorporated into the method of FIG. 19.

In some embodiments, the second information related to paging comprises DCI, e.g. the DCI in downlink notification 484. In some embodiments, the DCI has a CRC value that is scrambled by a paging identifier, e.g. a P-RNTI. In some embodiments, the DCI (e.g. the second indication in the DCI) indicates that a message providing an updated sensing configuration is being scheduled by the DCI. An example of an updated sensing configuration is any sensing configuration 702 message described earlier, e.g. in relation to FIGS. 15 to 17. The examples in FIGS. 15 to 17 may be incorporated into the method of FIG. 19. In some embodiments, the DCI may schedule the message providing the updated sensing configuration. Such is the case in FIG. 15 in which the DCI in downlink notification 484 schedules sensing configuration 702. In some embodiments, the method of FIG. 19 further includes the device transmitting the message providing the updated sensing configuration, and the apparatus receiving and decoding the message. The message may be transmitted in a data channel.

In some embodiments, the message providing the updated sensing configuration is either cell-specific or apparatus-specific. An example of a cell-specific updated sensing configuration is that illustrated in Example A of FIG. 16. An example of an apparatus-specific updated sensing configuration is that illustrated in Examples B and C of FIG. 16. The examples in FIG. 16 may be incorporated into the method of FIG. 19. The message providing the updated sensing configuration (e.g. the sensing configuration 702 of any one of the three examples in FIG. 16) may, in some embodiments, update a configuration related to at least one of: a resource used for performing the sensing; a signal used for performing the sensing; a carrier used for performing the sensing; or a carrier used for transmitting feedback obtained from the sensing.

In some embodiments, the message providing the updated sensing configuration is apparatus-specific and includes an ID that is specific to the apparatus or to a group of apparatuses including the apparatus, and the updated sensing configuration applies to the apparatus or to the group of apparatuses associated with the ID. An example of an ID specific to the apparatus is UE ID 1 shown in the sensing configuration 702 in Example B of FIG. 16. An example of an ID specific to a group of apparatuses is Group ID 1 in the sensing configuration 702 in Example C of FIG. 16.

In some embodiments, the method of FIG. 19 is performed by the apparatus when the apparatus is in a power-saving state, e.g. when the apparatus is in a wake-up duration of a power saving state. An example of a wake-up duration of a power-saving state is duration 402 in FIG. 6 or duration t1 in FIG. 7, 10, or 15.

In some embodiments, the method of FIG. 19 further includes the device subsequently transmitting, and the apparatus subsequently receiving, a sequence. Based on a detected power of the sequence, the apparatus refrains from decoding subsequent information related to paging. For example, the apparatus refrains from performing blind detection/decoding of the next paging occasion following the sequence. The sequence may indicate (e.g. through the detected power) that there is no paging or sensing trigger or sensing configuration for the apparatus in that upcoming paging occasion.

In the method of FIG. 19, the information including the indication is paging information. More generally, the information does not need to be paging information, e.g. as is the case in the variation described in relation to FIG. 18. Therefore, in a variation, the method steps shown in FIG. 19 may be modified to remove the reference to paging. For example, step 802 may include generating information including an indication used for triggering the apparatus to perform sensing. The apparatus may be in a power-saving state and monitor for the information. The information may be DCI and/or a message scheduled by the DCI. The DCI may be scrambled by a sensing-specific ID (e.g. Sensing-RNTI in FIG. 18). The remaining steps of FIG. 19 may generally remain the same in terms of the information being transmitted to and received by the apparatus, the apparatus decoding the information, obtaining the indication, and optionally performing sensing. The information is not related to paging.

Examples of an apparatus (e.g. ED or UE) and a device (e.g. TRP) to perform the various methods described herein are also disclosed.

The apparatus may include a memory to store processor-executable instructions, and at least one processor to execute the processor-executable instructions. When the processor executes the processor-executable instructions, the processor may be caused to perform the method steps of the apparatus as described herein, e.g. the method steps of the apparatus discussed in relation to FIG. 19. As one example, the processor may receive the information related to paging, and decode the information to obtain the indication that triggers the apparatus to perform the sensing. The processor may receive the information by receiving it at an input of the processor. In some embodiments, the information may be decoded by the processor to read the information to obtain the indication.

The device may include a memory to store processor-executable instructions, and at least one processor to execute the processor-executable instructions. When the processor executes the processor-executable instructions, the processor may be caused perform the method steps of the device as described above, e.g. the method steps of the device discussed in relation to FIG. 19. As one example, the processor may generate the information related to the paging, e.g. by assembling the information (e.g. into a message) and encoding it. The processor may then output the information for transmission to the apparatus. For example, the processor may instruct a transmitter to transmit the information.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by an apparatus, the method comprising:
receiving information related to paging, the information including an indication used for triggering the apparatus to perform sensing; and
decoding the information.

2. The method of claim 1, wherein the information comprises downlink control information (DCI), and the indication is in the DCI.

3. The method of claim 2, wherein the indication indicates that a sensing message is being scheduled by the DCI, and wherein the sensing message indicates at least one of: a type of the sensing to be performed by the apparatus; whether electromagnetic waves are to be transmitted from the apparatus; resources for transmitting the electromagnetic waves; resources for receiving the electromagnetic waves; resources for performing random access; or resources for transmitting feedback obtained from the sensing.

4. The method of claim 3, wherein the sensing message indicates an identifier (ID) that is specific to the apparatus or to a group of apparatuses including the apparatus, and wherein a configuration provided by the sensing message applies to the apparatus or to the group of apparatuses associated with the ID.

5. The method of claim 2, wherein the indication indicates a pattern of one or more bits in the DCI, and the pattern of the one or more bits indicates that a paging message is being scheduled by the DCI.

6. The method of claim 1, wherein the indication is a first indication, wherein the information related to the paging is first information, and the method further includes:
after the decoding the information, receiving second information related to paging, the second information including a second indication, the second indication indicating that a configuration related to the sensing has changed; and
decoding the second information.

7. The method of claim 6, wherein the second information comprises DCI, wherein the second indication is in the DCI, wherein the second indication indicates that a message providing an updated sensing configuration is being scheduled by the DCI, wherein the DCI schedules the message providing the updated sensing configuration, and wherein the method further includes:
receiving and decoding the message providing the updated sensing configuration.

8. The method of claim 7, wherein the message providing the updated sensing configuration is either cell-specific or apparatus-specific, and the message providing the updated sensing configuration updates a configuration related to at least one of: a resource used for performing the sensing; a signal used for performing the sensing; a carrier used for performing the sensing; or a carrier used for transmitting feedback obtained from the sensing.

9. The method of claim 8, wherein the message providing the updated sensing configuration is apparatus-specific and includes an ID that is specific to the apparatus or to a group of apparatuses including the apparatus, and wherein the updated sensing configuration applies to the apparatus or to the group of apparatuses associated with the ID.

10. The method of claim 1, wherein the method is performed by the apparatus in a wake-up duration of a power saving state.

11. The method of claim 1, further comprising:
after the decoding the information, receiving a sequence; and
based on a detected power of the sequence, refraining from decoding subsequent information related to the paging.

12. The method of claim 2, wherein the DCI indicates a cyclic redundancy check (CRC) value that is scrambled by a paging ID.

13. The method of claim 1, the method further comprising: performing the sensing, wherein the sensing comprises at least one of: sensing electromagnetic waves reflected from at least one object, or a sensor on the apparatus sensing a parameter.

14. A method performed by a device, the method comprising:
generating information related to paging, the information including an indication used for triggering an apparatus to perform sensing; and
transmitting the information.

15. The method of claim 14, wherein the information comprises downlink control information (DCI), and the indication is in the DCI.

16. The method of claim 15, wherein the indication indicates that a sensing message is being scheduled by the DCI, and wherein the sensing message indicates at least one of: a type of the sensing to be performed by the apparatus; whether electromagnetic waves are to be transmitted from the apparatus; resources to be used by the apparatus to transmit the electromagnetic waves; resources to be used by the apparatus to receive the electromagnetic waves; resources to be used by the apparatus for performing random access; or resources to be used by the apparatus to transmit feedback obtained from the sensing.

17. The method of claim 14, wherein the indication is a first indication, wherein the information related to the paging is first information, and the method further includes:
generating second information related to paging, the second information including a second indication, the second indication indicating that a configuration related to the sensing has changed; and
transmitting the second information.

18. The method of claim 17, wherein the second information comprises DCI, wherein the second indication is in the DCI, wherein the second indication indicates that a message providing an updated sensing configuration is being scheduled by the DCI, wherein the DCI schedules the message providing the updated sensing configuration, and wherein the method further includes:
transmitting the message providing the updated sensing configuration.

19. The method of claim 18, wherein the message providing the updated sensing configuration is either cell-specific or apparatus-specific, and the message providing the updated sensing configuration updates a configuration related to at least one of: a resource to be used by the apparatus for performing the sensing; a signal to be used by the apparatus for performing the sensing; a carrier to be used by the apparatus for performing the sensing; or a carrier to be used by the apparatus for transmitting feedback obtained from the sensing.

20. An apparatus comprising:
at least one processor; and
a memory storing processor-executable instructions that, when executed by the at least one processor, cause the apparatus to:
receive information related to paging, the information including an indication used for triggering the apparatus to perform sensing; and
decode the information.
